(19) United States
(12) Patent Application Publication
(10) Pub. No.: US 2004/0211763 A1
(43) Pub. Date: Oct. 28, 2004

(54) Beam guiding chamber of a laser processing machine

(76) Inventor: Martin Lambert, Stuttgart (DE)

Correspondence Address: FISH & RICHARDSON PC, 225 FRANKLIN ST, BOSTON, MA, 02110, US

(21) Appl. No.: 10/678,753

(22) Filed: Oct. 6, 2003

(30) Foreign Application Priority Data
Apr. 22, 2003 (DE) DE 203 06 336

(51) Int. Cl. B23K 26/12

(52) U.S. Cl. 219/121.84

(57) ABSTRACT

A laser processing machine includes a beam guiding chamber, a gas supply for flushing the beam guiding chamber, and a pressure relief valve coupled to the beam guiding chamber for releasing the flushing gas from the beam guiding chamber.

### CLAIM OF PRIORITY

This application claims priority under 35 USC §119 to German patent application serial number DE 203.06.336, filed on Apr. 22, 2003, the entire contents of which is hereby incorporated by reference.

### TECHNICAL FIELD

The invention concerns a beam guiding chamber of a laser processing machine with means for flushing the beam guiding chamber.

### BACKGROUND

A beam guiding chamber is disclosed in Patent Cooperation Treaty Application No. WO 95/33594 and in U.S. Pat. No. 6,624,386.

Known optical beam guiding chambers of CO₂ laser processing machines are flushed with gas (e.g., nitrogen). Gas flushing within the guiding chamber occurs at a pressure that is higher than that of the surroundings outside the beam guiding chamber. This ensures that gas or foreign matter cannot enter the beam guiding chamber from the outside. This overpressure is relevant mainly because parts of the beam guiding chamber are formed by a folded or unfolded expansion bellows. However, the expansion bellows is, at least to a small degree, permeable to gas, at least after a certain period of use, such that later adjustment of the gas overpressure is required.

Other known laser processing machines include a beam guiding chamber through which a constant uncontrolled gas volume flows. In such machines gas is consumed at a constant high level regardless of variations in the operating conditions.

### SUMMARY

A laser processing machine having a beam guiding chamber flushed with gas and vented through a pressure relief valve is disclosed.

In a first general aspect, a laser processing machine includes a beam guiding chamber adapted for flushing with a flushing gas and a pressure relief valve coupled to the beam guiding chamber for releasing the flushing gas from the beam guiding chamber.

The laser processing machine can include one or more of the following features. The pressure relief valve can include a valve chamber, and an inner chamber of the beam guiding chamber can be connected to the valve chamber. The pressure relief valve further can include a movably disposed valve disk for opening and closing the valve chamber to an atmosphere outside the beam guiding chamber. The movably disposed valve disk can be attached to a pin movably located within a chamber of the pressure relief valve. The beam guiding chamber can be adapted for flushing with a flushing gas at an overpressure compared to an atmosphere surrounding the beam guiding chamber. The pressure relief valve can be adapted to be opened passively when the overpressure within the beam guiding chamber exceeds a critical overpressure.

In a second general aspect, a method of flushing a beam guiding chamber of a laser processing machine includes flushing the beam guiding chamber with a flushing gas and releasing a portion of the flushing gas from the beam guiding chamber through a pressure relief valve.

The method of flushing a beam guiding chamber of a laser processing machine can include one or more of the following features. The method can further include flushing the beam guiding chamber with a flushing gas having an overpressure compared to an atmosphere surrounding the beam guiding chamber. The flushing gas can be passively released through the pressure relief value due to the overpressure of the gas acting on the valve to open the valve when the overpressure exceeds a predetermined overpressure.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram of a part of a laser processing machine.

FIG. 2 is a schematic diagram of a pressure relief valve of the laser processing machine.

Like reference symbols in the various drawings indicate like elements.

### DETAILED DESCRIPTION

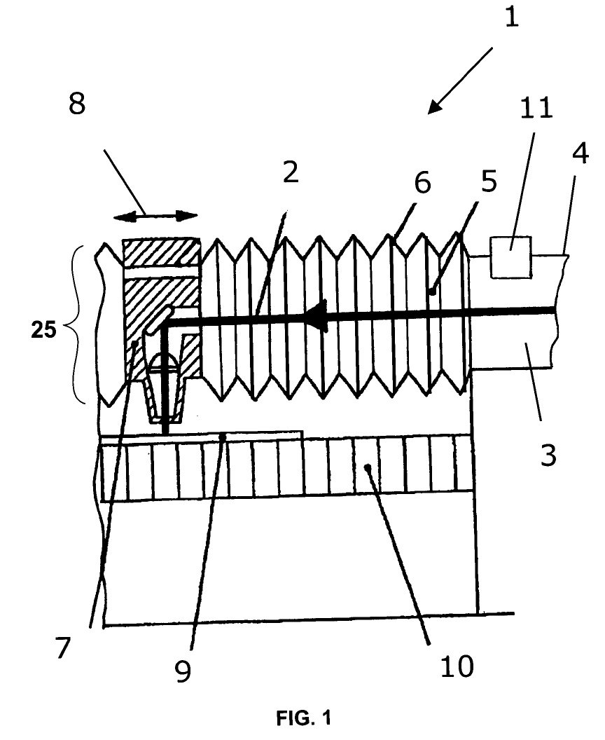

Referring to FIG. 1, a laser processing machine 1 includes a laser (e.g., a CO₂ laser) and a beam guiding chamber 25 through which the laser beam 2 (e.g., a CO₂ laser beam) passes and which completely encloses the laser beam 2 from the surrounding atmosphere. The entire beam guiding chamber 25 is flushed with gas (e.g., nitrogen or compressed air) at a slight overpressure compared to the atmosphere outside the beam guiding chamber 25. Flushing of the gas-tight beam guiding chamber 25 provides a constant overpressure within the beam guiding chamber. Thus, gases and/or particles produced during laser processing such as cutting or welding do not come within the beam guiding chamber and into the laser beam path where they can soil optical elements of the laser processing machine.

The beam guiding chamber 25 includes a beam guiding tube 3 of a beam guiding component 4 and a bellows chamber 5 of an expansion bellows 6. The laser beam 2 generated by a laser (not shown) is supplied to a processing head 7 through the beam guiding tube 3 and the bellows chamber 5. The processing head 7 is disposed such that it can be displaced in a plane (e.g., in the direction of the double arrow 8) to permit processing of a workpiece 9 disposed on a workpiece support 10 at several processing locations by the laser beam 2.

To produce a predetermined overpressure in the beam guiding chamber in a simple and controlled fashion, a pressure relief valve 1I is integrated in the beam guiding chamber component 4. The pressure relief valve 11 ensures that the beam guiding chamber 25 can be pressurized up to a predetermined overpressure. The beam guiding chamber may be flushed with a constant gas volume flow. If the set gas pressure exceeds the predetermined overpressure of the pressure relief valve or pressure control valve, the valve automatically opens which ensures on the one hand constant volume flow. On the other hand, overload of the beam guiding chamber is prevented. An inadmissibly high inner gas pressure in the beam guiding chamber is prevented.

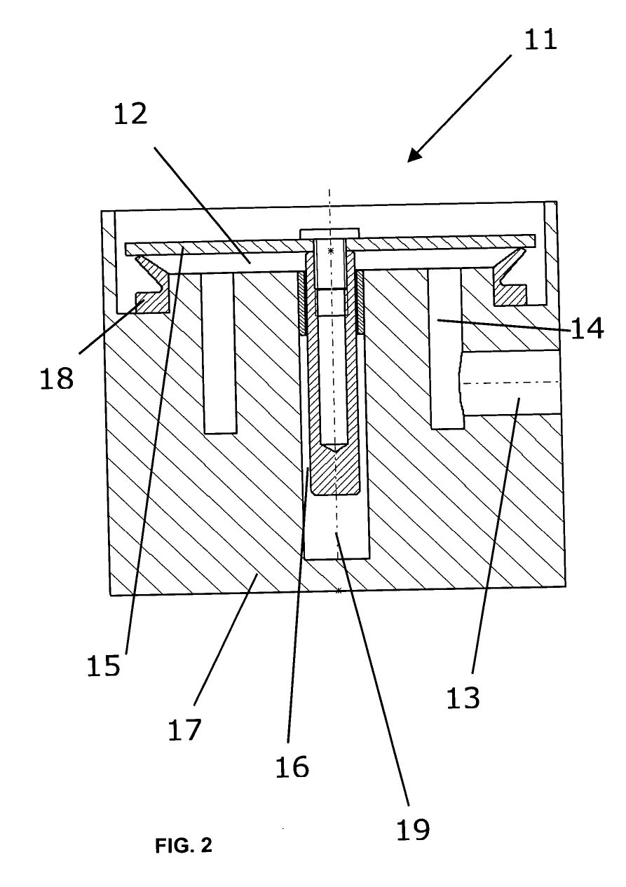

Referring to FIG. 2, a valve chamber 12 of the pressure relief valve 11 is operably connected to the beam guiding tube 3 through bores 13 and 14. The system pressure within the beam guiding chamber can therefore act on a valve disk 15 of the pressure relief valve 11. The valve disk 15 is moveably disposed by a moveable pin 16 in a chamber 19 of a basic support 17.

When the beam guiding chamber 3 is flushed with gas, the pressure of the gas in the beam guiding chamber exerts a force on the valve disk 15, and when a certain critical gas pressure is exceeded the valve opens. The cooperation between the gas pressure in the beam guiding chamber 3 and the weight of the valve disk 15 opens or closes the pressure relief valve 11. Thus, when the gas pressure within the beam guiding chamber 3 is below the critical pressure, the valve disk 15 is supported on a seal 18 and seals the beam guiding chamber 3 to the outside atmosphere. When the gas pressure within the beam guiding chamber 3 is above the critical pressure, the contact point between valve disk 15 and seal 18 is broken, the valve disk 15 is lifted from the seal 18, and the system pressure is reduced because gas leaks out of the beam guiding chamber 3 through the annular gap between the valve disk 15 and the seal 18. No additional energy is required for actuating the pressure control valve. The pressure relief or pressure control valve represents a “passive” component. The force for opening the pressure relief valve can additionally be influenced via the weight of a pin in accordance with claim 4.

### OTHER EMBODIMENTS

A number of embodiments of the invention have been described. Nevertheless, it will be understood that various modifications may be made. Accordingly, other embodiments are within the scope of the following claims.

What is claimed is:

1. A laser processing machine comprising:
a beam guiding chamber adapted for flushing with a flushing gas; and
a pressure relief valve coupled to the beam guiding chamber for releasing the flushing gas from the beam guiding chamber.

2. The laser processing machine of claim 1, wherein the pressure relief valve includes a valve chamber and wherein an inner chamber of the beam guiding chamber is connected to the valve chamber.

3. The laser processing machine of claim 2, wherein the pressure relief valve further includes a movably disposed valve disk for opening and closing the valve chamber to an atmosphere outside the beam guiding chamber.

4. The laser processing machine of claim 3, wherein the movably disposed valve disk is attached to a pin movably located within a chamber of the pressure relief valve.

5. The laser processing machine of claim 1, wherein the beam guiding chamber is adapted for flushing with a flushing gas at an overpressure compared to an atmosphere surrounding the beam guiding chamber.

6. The laser processing machine of claim 5, wherein the pressure relief valve is adapted to be opened passively when the overpressure within the beam guiding chamber exceeds a critical overpressure.

7. A method of flushing a beam guiding chamber of a laser processing machine, the method comprising:
flushing the beam guiding chamber with a flushing gas; and
releasing a portion of the flushing gas from the beam guiding chamber through a pressure relief valve.

8. The method of claim 7, further comprising flushing the beam guiding chamber with a flushing gas having an overpressure compared to an atmosphere surrounding the beam guiding chamber.

9. The method of claim 8, wherein the flushing gas is passively released through the pressure relief value due to the overpressure of the gas acting on the valve to open the valve when the overpressure exceeds a predetermined overpressure.
